(19) United States
(12) Patent Application Publication
(10) Pub. No.: US 2025/0384580 A1
(43) Pub. Date: Dec. 18, 2025

(54) IMAGE PROCESSING APPARATUS, PROCESSING METHOD OF IMAGE PROCESSING APPARATUS, AND STORAGE MEDIUM

(71) Applicant: CANON KABUSHIKI KAISHA, Tokyo (JP)

(72) Inventor: WAKI MIDORIKAWA, Kanagawa (JP)

(21) Appl. No.: 19/231,223

(22) Filed: Jun. 6, 2025

(30) Foreign Application Priority Data
Jun. 17, 2024 (JP) 2024-097685

(51) Int. Cl. G06T 7/73; G06T 7/13; G06T 7/246

(52) U.S. Cl. CPC G06T 7/74; G06T 7/13; G06T 7/248

(57) ABSTRACT

An image processing apparatus includes one or more memories storing one or more instructions, and one or more processors that, upon execution of the stored one or more instructions, cause the image processing apparatus to select from a first image a plurality of patches to be used for detecting displacement in a direction out of a plurality of directions, search a second image for regions corresponding to the plurality of selected patches, and store amounts of change in coordinates and direction between a patch in the first image that has been successfully searched and a region corresponding to the successfully searched patch in the second image, assign a weight of the amounts of change to the patch that has been successfully searched, and perform positioning of the second image with respect to the first image using the amounts of change and the weight to correct the second image.

### BACKGROUND

### Field

The present disclosure relates to an image processing apparatus, a processing method of the image processing apparatus, and a storage medium.

### Description of the Related Art

In a case where image processing is performed using images captured by a camera, processing is executed based on the assumption that images of an identical subject captured at different times are matched with each other. For example, in processing captured images to extract a foreground by background subtraction, it is possible to extract the shape of an object with high accuracy by using input images in which images of an identical subject are matched with each other. In a case where a relationship among a plurality of cameras is obtained by camera calibration and images captured by the plurality of cameras are combined to generate a video, a camera parameter during imaging needs to be matched with a result of the calibration.

U.S. Pat. No. 10,121,262 discusses a method of extracting a contour of a linear subject in a captured image as a feature (patch) and using a plurality of patches between images captured at different times to perform positioning with high accuracy. Using only these patches, however, it is impossible to detect movement parallel to the contour of the linear subject. Thus, a plurality of patches extracted from contours of linear subjects in different directions is combined to obtain a deformation amount of the captured image. An appropriate subject for a patch is acquired mainly from a line in the background of an image, but it may be shielded by a human figure or an object in the foreground.

### SUMMARY

To perform accurate positioning with respect to movement in any direction, information regarding displacement needs to be obtained from a plurality of patches for correcting in different directions. However, where there are few patches that can be used for correction in a direction, accuracy of vibration correction in the direction decreases. For example, consider the following scenario. Assuming there are two patches for detecting displacement in an X-direction and a subject moves by −3 pixels in the X-direction, displacement by +3 pixels is obtained from one of the two patches and displacement by −3 pixels is obtained from the other of the two patches.

When taking an average of these two displacement amounts to obtain a deformation amount of the captured image, the average displacement amount is 0, which causes a gap of −3 pixels based on the movement of the subject in the X-direction. When displacement data of either of the two patches is randomly selected, a gap of −6 pixels occurs in a frame in which the patch, from which displacement by +3 pixels is obtained, is selected.

When a frame in which displacement by +3 pixels is obtained and a frame in which displacement by −3 pixels is obtained are randomly switched (i.e., the other of the two patches is randomly selected), images obtained as a result of correction appear to vibrate for an amount of 6 pixels because there is a gap of −6 pixels in first frame and a gap of 0 pixels in the second frame. The displacement by +3 pixels is an error. In a case where solar irradiation changes or another subject having a similar shape exists in a patch region, there is a possibility that an erroneously estimated displacement value is obtained. In this manner, in a case where there are few patches that can be used for correction in a direction, the correction is susceptible to the influence of erroneous estimation of displacement.

According to an aspect of the present disclosure, an image processing apparatus comprises one or more memories storing one or more instructions, and one or more processors that, upon execution of the stored one or more instructions, cause the image processing apparatus to select from a first image a plurality of patches to be used for detecting displacement in a direction out of a plurality of directions, search a second image for regions corresponding to the plurality of selected patches, and store amounts of change in coordinates and direction between a patch in the first image that has been successfully searched and a region corresponding to the successfully searched patch in the second image, assign a weight of the amounts of change to the patch that has been successfully searched, and perform positioning of the second image with respect to the first image using the amounts of change and the weight of the amounts of change to correct the second image.

Further features of the present disclosure will become apparent from the following description of exemplary embodiments with reference to the attached drawings.

### BRIEF DESCRIPTION OF THE DRAWINGS

FIG. 1 is a diagram illustrating a configuration example of an image processing system.

FIG. 2 is a diagram illustrating a hardware configuration example of an image processing apparatus.

FIG. 3A is a view illustrating a patch selection example in a reference image.

FIG. 3B is a view illustrating a patch selection example in a correction target image.

FIG. 4 is a flowchart regarding a priority determination unit.

FIG. 5 is a chart illustrating an example of the flow of an operation performed by the image processing apparatus.

FIG. 6 is a diagram illustrating an example of a patch format.

### DESCRIPTION OF THE EMBODIMENTS

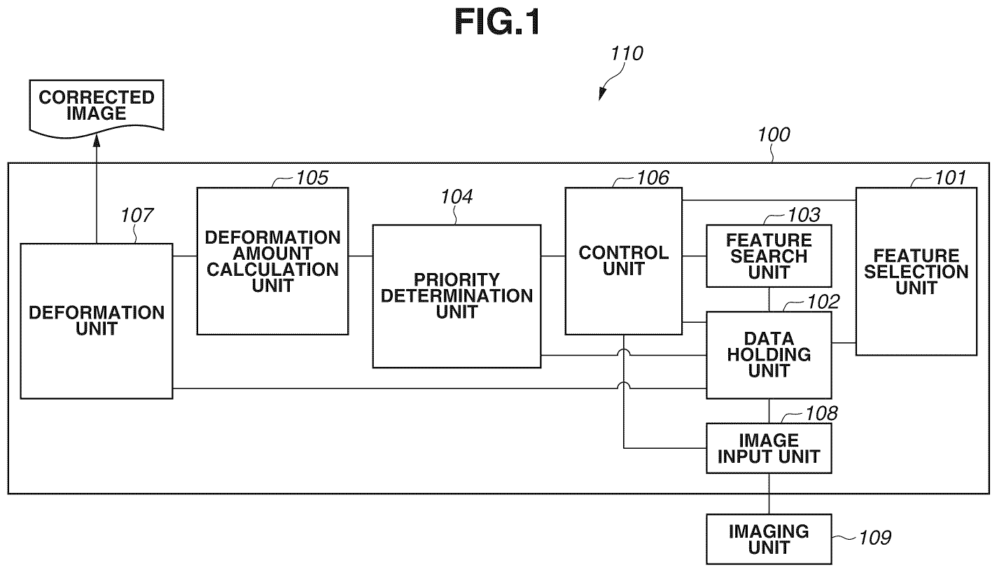

FIG. 1 is a diagram illustrating a configuration example of an image processing system 110 according to an exemplary embodiment. The image processing system 110 includes an image processing apparatus 100 and an imaging unit 109.

The image processing apparatus 100 includes a feature selection unit 101, a data holding unit 102, a feature search unit 103, a priority determination unit 104, a deformation amount calculation unit 105, a control unit 106, a deformation unit 107, and an image input unit 108.

The imaging unit 109 captures a first image and a second image. The first image captured by the imaging unit 109 at the time of calibration (hereinafter referred to as a reference image) and the second image serving as a correction target (hereinafter referred to as a correction target image) are stored by the image input unit 108 in the data holding unit 102.

The deformation unit 107 uses a deformation amount calculated by the deformation amount calculation unit 105 to correct the correction target image read out from the data holding unit 102 and outputs a corrected image.

The feature selection unit 101 stores, in the data holding unit 102, a plurality of patches (features) selected from the reference image stored in the data holding unit 102. Each patch can be selected with use of, for example, the method described in U.S. Pat. No. 10,121,262. Each patch is a feature that exists in the reference image, and is, for example, a contour of a linear subject that exists in the reference image.

The feature search unit 103 searches the correction target image stored in the data holding unit 102 for a region corresponding to each patch. The feature search unit 103 stores, in the data holding unit 102, amounts of change in coordinates and direction from the reference image stored in the data holding unit 102 so that the amounts of change in coordinates and direction are associated with each patch as a displacement of each patch.

The control unit 106 causes the priority determination unit 104 to use a search result obtained by the feature search unit 103 and information regarding a position and type of a patch (horizontal vibration detection patch/vertical vibration detection patch) to calculate a weight to be assigned to each patch. The result of searching patches includes search success/failure information indicating whether a feature matched with a patch has been found in the correction target image and whether displacement in a direction in which the patch whose corresponding feature has been found is detected.

The deformation amount calculation unit 105 uses the weights obtained by the priority determination unit 104 and the information regarding the position and the type of the patch to obtain a deformation amount of the correction target image.

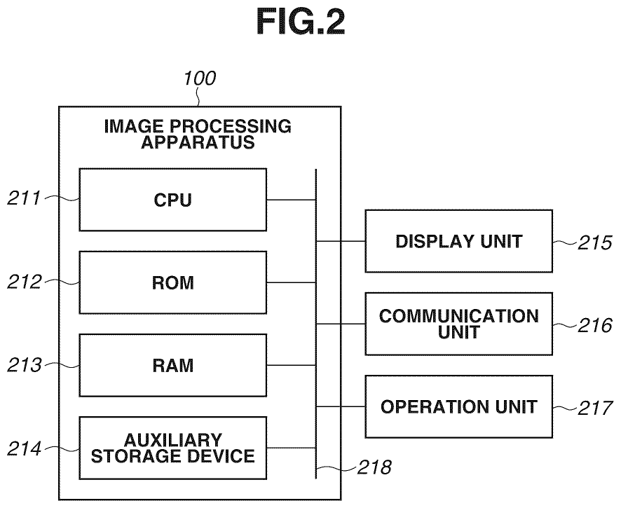

FIG. 2 is a block diagram illustrating a hardware configuration example of the image processing apparatus 100 illustrated in FIG. 1. As illustrated in FIG. 2, the image processing apparatus 100 includes a central processing unit (CPU) 211, a read-only memory (ROM) 212, a random-access memory (RAM) 213, an auxiliary storage device 214, and a bus 218, and is connected to a display unit 215, a communication unit 216, and an operation unit 217.

The CPU 211 uses a computer program and data stored in the ROM 212 or the RAM 213 to control the whole of the image processing apparatus 100. The CPU 211 executes a program to implement functions of the functional constituent units of the image processing apparatus 100 illustrated in FIG. 1.

The ROM 212 stores a program and data that need not be changed. The RAM 213 temporarily stores a program and data supplied from the auxiliary storage device 214, image data supplied from outside the image processing apparatus 100 via the communication unit 216, and other data.

The auxiliary storage device 214 includes, for example, a hard disk or a solid-state drive, and is used to store an image received from the communication unit 216.

The display unit 215 includes, for example, a liquid crystal display, and displays a corrected image and a graphical user interface (GUI) for a user to operate the image processing apparatus 100.

The operation unit 217 includes, for example, a keyboard and a mouse, and outputs an instruction of various kinds to the CPU 211 in response to an input received from the user.

The communication unit 216 facilitates communication between an external apparatus and the image processing apparatus 100. The communication unit 216 performs the communication function performed by the image input unit 108 or the deformation unit 107 in FIG. 1. Where the image processing apparatus 100 is connected to the external apparatus in a wired manner, for example, a local area network (LAN) cable or the like is connected to the communication unit 216. Where the image processing apparatus 100 can perform wireless communication with the external apparatus, for example, the communication unit 216 includes an antenna.

The bus 218 connects each unit of the image processing apparatus 100 and each of the display unit 215, the communication unit 216, and the operation unit 217 to transmit information.

Where the feature search unit 103 has succeeded in the search and has detected in the correction target image a plurality of regions corresponding to patches in the reference image, and the search result is biased such that almost all the directions of patches from which valid displacements have been obtained are identical and there are extremely few patches in different directions, the image processing apparatus 100 according to the present exemplary embodiment assigns a weight of displacement. Where a search result is not biased, the image processing apparatus 100 does not perform weighting. Where a sufficient number of patches to allow for statistical processing has been successfully searched and it is determined that the data indicating displacement are not biased, the image processing apparatus 100 is capable of obtaining amounts in change in coordinates and direction without performing weighting. A case where the feature search unit 103 has been unable to detect a corresponding region and has failed in the search will be described separately.

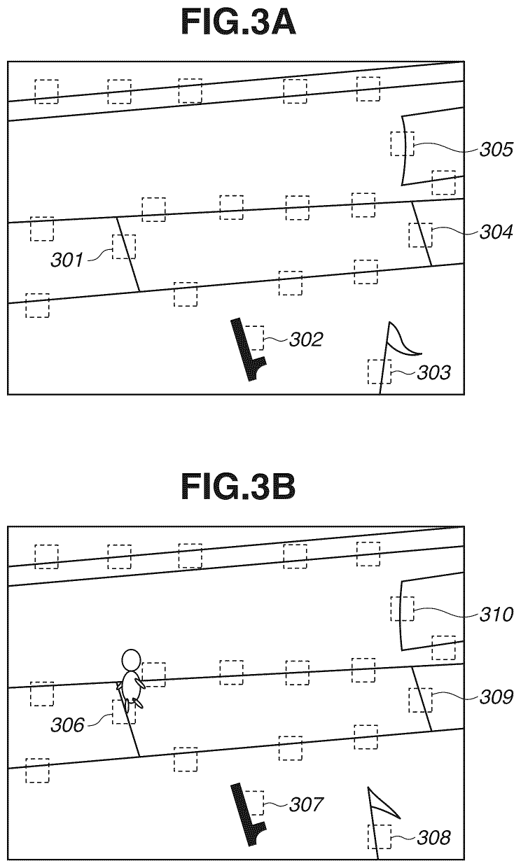

A use case example in which the image processing apparatus 100 performs weighting is described with reference to FIGS. 3A and 3B.

FIG. 3A illustrates an example of patches selected from the reference image. FIG. 3B illustrates, in the correction target image, an example of regions corresponding to the respective patches in the reference image.

In the example in FIG. 3A, patches 301 to 305 are selected as patches each including components that can be used for positioning to eliminate an orientation shift of a camera in a lateral direction (hereinafter referred to as horizontal vibration detection patches).

The horizontal vibration detection patch is typically a patch including a longitudinal edge component.

The image processing apparatus 100 according to the present exemplary embodiment divides patches into two groups. One group includes patches each of which includes components in directions ranging from 45° to 135°, and the other group includes other patches in directions outside that range (hereinafter referred to as vertical vibration detection patches).

The vertical vibration detection patch is typically a patch including a lateral edge component.

The example of patches including components in the horizontal and vertical directions has been provided for the sake of explanatory convenience, but the configuration is not limited to this example. For example, there may be a detection patch at every component in a 45° direction.

In the present exemplary embodiment, where the number of patches from which valid displacement has been successfully acquired and that belong to either of the groups is fewer than a threshold of three, assume that the image processing apparatus 100 selects a patch that should be prioritized from the few patches and performs weighting.

Since the issue in a case where there are two patches has been described, assume that a threshold is three.

The threshold value is provided above for the sake of explanatory convenience and is not limited to three. The threshold is preferably the obtained number of data indicating displacement at or below which it is impossible to perform statistical processing to estimate a valid deformation amount.

Where a threshold is three and the obtained number of data indicating displacement is three or less, it is impossible to perform statistical processing. Alternatively, the image processing apparatus 100 may be configured to employ an embodiment of the present method where the number of data is more than a threshold of three, but the number of valid patches is insufficient to expect accuracy in normal statistical processing.

The threshold value may be the number of patches per area, or a value based on the number of patches determined in the reference image. The number of patches per area can be defined so that, for example, one frame is divided into several rectangles and N patches belonging to each of the two groups exist in each rectangle. When selecting patches in the reference image, the image processing apparatus 100 may tally the patches belonging to each of the two groups and selects a patch that should be prioritized from the few patches and performs weighting where the number of patches is less than the threshold value.

In the correction target image in FIG. 3B, a region 306 corresponding to patch 301 in FIG. 3A is shielded by a foreground object, and positions and shapes of subjects change in regions 308 and 310, which correspond to patches 303 and 305, respectively, in FIG. 3A.

In a region where shapes of a subject are not matched with each other between the reference image and the correction target image, the feature search unit 103 is unable to detect a region corresponding to a patch or calculate displacement.

In FIG. 3A, there are only two patches, the patches 302 and 304, in which no change is made in shapes of subjects between the reference image and the correction target image and that can be used when the correction target image in FIG. 3B is corrected.

In the present example, there are two patches from which displacement in the lateral direction is detected. In this case, even though two pieces of data indicating different displacement can be obtained, the image processing apparatus 100 is unable to determine which data is correct, and thus performs weighting. Also, where there is only one piece of data indicating displacement, the image processing apparatus 100 is unable to perform statistical processing, and thus performs weighting.

In a case where there are pieces of data indicating displacement of a plurality of patches at the time of weighting, it is possible to selects a patch that should be prioritized from the few patches and performs weighting based on a direction of each patch. Alternatively, the image processing apparatus 100 may use a feature amount to evaluate a degree of similarity of patches between the reference image and the correction target image and determine priority ranks of the patches. This will be described in detail later.

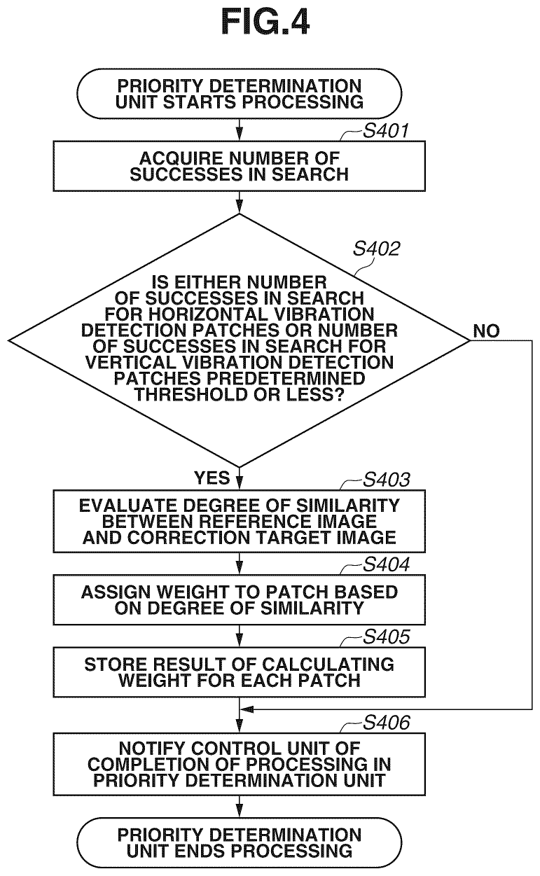

FIG. 4 is a flowchart describing an example of an operation of the priority determination unit 104 in FIG. 1. The CPU 211 executes a program to implement a function of the priority determination unit 104.

In step S401, the priority determination unit 104 acquires patches from the data holding unit 102. At this time, the priority determination unit 104 acquires, from the data holding unit 102, on a patch-by-patch basis, information regarding a position and type of a patch (horizontal vibration detection patch/vertical vibration detection patch), information regarding a status as to whether the feature search unit 103 has succeeded or failed in searching for the patch in the correction target image, and information regarding displacement.

If there is a failure to find, in the correction target image, a feature that is matched with a patch in the reference image due to shielding by the foreground or a change in a subject, the feature search unit 103 determines that the status of the search for the patch is a failure. If a feature in the correction target image is matched with the corresponding patch in the reference image, the feature search unit 103 determines that the status of the search for the patch is a success, and information regarding valid displacement becomes available.

The priority determination unit 104 tallies the number of successfully searched patches on a patch-type-by-patch-type basis, and obtains the number of successfully searched horizontal vibration detection patches each including components in directions from 45° to 135° and the number of successfully searched vertical vibration detection patches each including components in directions other than 45° to 135°.

In step S402, the priority determination unit 104 determines whether either the number of successfully searched horizontal vibration detection patches or the number of successfully searched vertical vibration detection patches is equivalent to a predetermined threshold or less.

The threshold is, for example, three. If it is determined that either the number of successfully searched horizontal vibration detection patches or the number of successfully searched vertical vibration detection patches is equivalent to the predetermined threshold or less (YES in step S402), the priority determination unit 104 proceeds to execute processing in step S403. If it is determined that both the number of successfully searched horizontal vibration detection patches and the number of successfully searched vertical vibration detection patches are each more than the predetermined threshold (NO in step S402), the priority determination unit 104 proceeds to execute processing in step S406.

Types of patches are not limited to the two types of horizontal vibration detection patches and vertical vibration detection patches, and there may be three types or more. In the present example, in step S402, the priority determination unit 104 determines whether the number of patches that have been successfully searched, out of the patches for detecting displacement in a direction, is equivalent to the threshold or less. If it is determined that the number of patches that have been successfully searched, out of the patches for detecting displacement in the direction, is equivalent to the predetermined threshold or less (YES in step S402), the priority determination unit 104 proceeds to execute processing in step S403. If it is determined otherwise (NO in step S402), the priority determination unit 104 proceeds to execute processing in step S406.

In step S403, the priority determination unit 104 evaluates a degree of similarity between a patch in the reference image stored in the data holding unit 102 and a region corresponding to the patch in the correction target image. The feature selection unit 101 stores, in the data holding unit 102, for example, a histogram of normal vectors as the feature amount of each patch with respect to all the patches selected from the reference image. To generate the histogram of normal vectors, the feature selection unit 101 detects an edge in an image, calculates a normal vector of each point on the detected edge, and obtains a direction of the detected edge. Because a contour that exists in a small region of a patch is relatively simple, it is possible to compare shape information regarding a subject in the patch by expressing distributions of normal vectors defined by the contour as histograms and comparing them.

When evaluating a degree of similarity, the feature selection unit 101 generates a histogram of normal vectors with respect to the obtained region of the correction target image corresponding to the patch. When calculating a mutual information amount regarding the histograms of normal vectors in the reference image and the correction target image, the feature selection unit 101 generates a value from −1 to 1. In a case where there is a higher degree of similarity between the patch in the reference image and the region in the correction target image, the feature selection unit 101 generates a mutual information amount that is closer to 1. Thus, in step S404, the priority determination unit 104 assigns to the patch a weight corresponding to the mutual information amount regarding the histograms of normal vectors.

Assuming that a total bin number of a histogram of normal vectors Hk is N, an average value in the histogram of normal vectors Hk is expressed by the following expression.

$$\overline{{H}_{k}} = \frac{1}{N} {\sum }_{J} {H}_{k} ( J ) \qquad ( 1 )$$

Assuming that the histogram of normal vectors in the reference image is Hr and the histogram of normal vectors in the correction target image is Hc, a mutual information amount d regarding the histograms of normal vectors (Hr, Hc) is expressed by the following expression.

$$d ( {H}_{r} , {H}_{c} ) = \frac{{\sum }_{l} ( {H}_{r} ( I ) - \overline{{H}_{r}} ) {\sum }_{l} ( {H}_{c} ( I ) - \overline{{H}_{c}} )}{\sqrt{{\sum }_{l} {( {H}_{r} ( I ) - \overline{{H}_{r}} )}^{2} {\sum }_{l} {( {H}_{c} ( I ) - \overline{{H}_{c}} )}^{2}}} \qquad ( 2 )$$

The priority determination unit 104 assigns a higher weight to a patch when the mutual information amount d regarding the histograms of normal vectors (Hr, Hc) is closer to 1.

In step S404, the priority determination unit 104 calculates a weight to be assigned to a patch from which a value of the mutual information amount d regarding the histograms of normal vectors (Hr, Hc) obtained in step S403 is larger than 0. The priority determination unit 104 calculates the weight using the number of all patches that have been successfully searched, the number of vertical vibration detection patches, the number of horizontal vibration detection patches, and the number of patches stored in the feature selection unit 101.

Consideration is given to a case where weights are assigned to two horizontal vibration detection patches assuming that the number of successfully searched horizontal vibration detection patches is Nv, the number of successfully searched vertical vibration detection patches is Nh, and the number of all patches that have been successfully searched is Na.

The priority determination unit 104 performs weighting so that, out of the two horizontal vibration detection patches, a weight to be assigned to a prioritized patch is ((Nh−1)/Nv)+1 and a weight to be assigned to the other patch is (Nh−1)/Nv, and the number of data indicating weighted horizontal vibration detection patches is (Nh−1)/Nv.

In a case where the number of successfully searched vertical vibration detection patches Nh is 13 and the number of successfully searched horizontal vibration detection patches Nv is 2, a weight to be assigned to the horizontal vibration detection patch having higher priority is ((13−1)/2)+1=7, and a weight to be assigned to the other horizontal vibration detection patch is (13−1)/2=6.

In a case where the number of successfully searched vertical vibration detection patches Nh is 16 and the number of successfully searched horizontal vibration detection patches Nv is 2, a weight to be assigned to the horizontal vibration detection patch having higher priority is ((16−1)/2)+1=8.5, and a weight to be assigned to the other horizontal vibration detection patch is (16−1)/2=7.5.

The priority determination unit 104 assigns the weights obtained here to the respective patches and assigns 0 to patches that are not subjected to weighting.

As described above, the priority determination unit 104 functions as a setting unit and assigns a weight to a patch that has been successfully searched by the feature search unit 103. This weight is a weight of amounts of change in coordinates and direction between the patch in the reference image and the region corresponding to the patch in the correction target image.

The priority determination unit 104 assigns a weight based on a degree of similarity between a patch in the reference image and a region corresponding to the patch in the correction target image.

For example, the priority determination unit 104 assigns a weight based on a degree of similarity between a direction of an edge detected in a patch in the reference image and a direction of an edge detected in a region corresponding to the patch in the correction target image.

Specifically, the priority determination unit 104 assigns a weight based on a degree of similarity between a histogram of normal vectors of respective points on an edge detected in a patch in the reference image and a histogram of normal vectors of respective points on an edge detected in a region corresponding to the patch in the correction target image.

The priority determination unit 104 assigns a higher weight as the above-mentioned degree of similarity increases.

In step S405, the priority determination unit 104 stores the weight calculated in step S404 in association with each patch.

In step S406, the priority determination unit 104 notifies the control unit 106 that the priority determination unit 104 has completed its processing. The control unit 106 uses information regarding patches to which weights have been assigned to instruct the deformation amount calculation unit 105 to calculate a deformation amount.

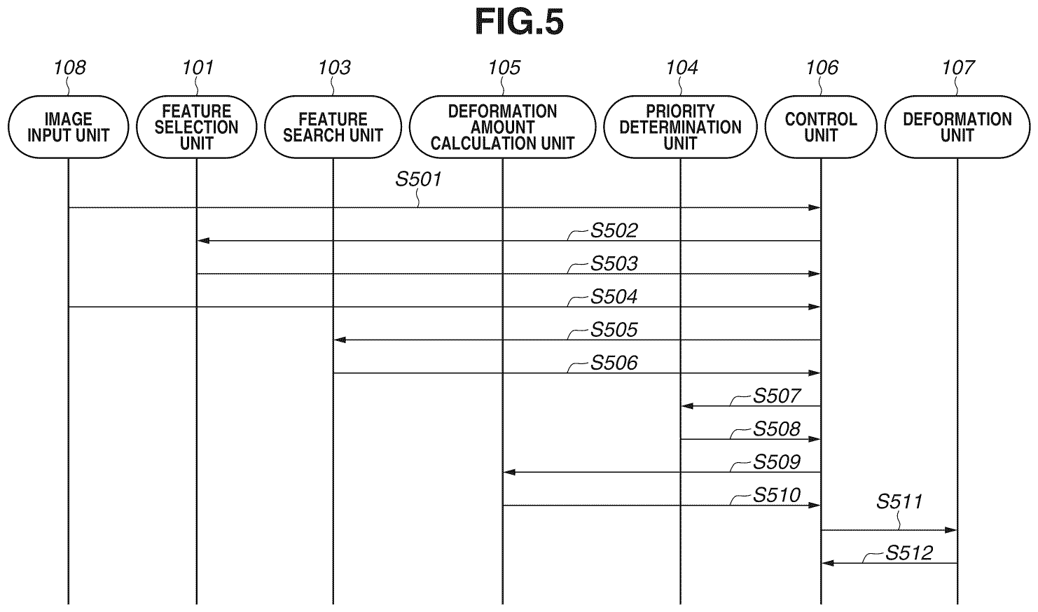

FIG. 5 is a chart illustrating an example of an operation of the image processing apparatus 100 according to the present exemplary embodiment. A processing method of the image processing apparatus 100 is now described.

In step S501, the image input unit 108 inputs the reference image captured by the imaging unit 109, stores the reference image in the data holding unit 102, and notifies the control unit 106 that image input has been completed.

In step S502, the control unit 106 instructs the feature selection unit 101 to select patches from the reference image. The control unit 106 instructs the feature selection unit 101 to calculate, in addition to the coordinates and direction of each patch, a histogram of normal vectors in each patch as an evaluation value at the time of selection of patches.

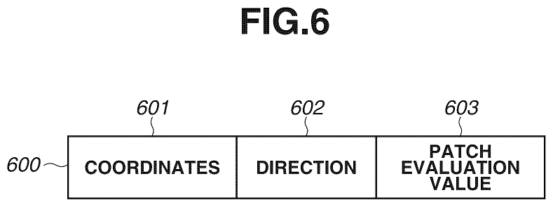

The feature selection unit 101 selects a plurality of patches from the reference image stored in the data holding unit 102. Specifically, the feature selection unit 101 selects, from the reference image, a plurality of patches, each of which is used to detect displacement in one direction out of a plurality of directions. The feature selection unit 101 calculates, as illustrated in FIG. 6, coordinates 601, a direction 602, and a patch evaluation value (histogram of normal vectors) 603 for each patch, and stores these pieces of data in the data holding unit 102.

For example, the feature selection unit 101 selects, from the reference image, a plurality of horizontal vibration detection patches for detecting displacement in the horizontal direction and a plurality of vertical vibration detection patches for detecting displacement in the vertical direction. The plurality of horizontal vibration detection patches each includes a longitudinal edge component. The plurality of vertical vibration detection patch each includes a lateral edge component.

FIG. 6 is a diagram illustrating an example of a patch format used in the present exemplary embodiment. A patch format 600 includes the coordinates 601, the direction 602, and the patch evaluation value 603. The patch evaluation value 603 is an evaluation value for a degree of similarity between the reference image and the correction target image, and it is possible to use the histogram of normal vectors as a result of detection of normal vectors in the region selected from the correction target image as being corresponding to the patch in the reference image. Alternatively, in an embodiment that does not use a degree of similarity between images, an aggregation of values obtained from a peripheral region of a feature point with the use of an algorithm that defines a feature and that is described in U.S. Pat. No. 10,121,262 may be used as the patch evaluation value 603.

In step S503, the feature selection unit 101 notifies the control unit 106 that selection of the patches has been completed. When the selection of the patches is completed, the image input unit 108 inputs the correction target image captured by the imaging unit 109 and stores the correction target image in the data holding unit 102. This allows the control unit 106 to start generation of the corrected image. Thereafter, the image input unit 108 handles an image input from the imaging unit 109 as a frame of the correction target image.

In step S504, the image input unit 108 notifies the control unit 106 that input of the correction target image has been completed.

In step S505, the control unit 106 instructs the feature search unit 103 to obtain a correspondence relationship for each patch with respect to the correction target image stored in the data holding unit 102. The feature search unit 103 searches the correction target image for a region corresponding to each of the plurality of patches, which is selected by the feature selection unit 101, in the reference image.

If a region corresponding to each of the patches in the reference image is found in the correction target image, the feature search unit 103 stores a status indicating a successful search. If a region corresponding to each of the patches in the reference image is not found in the correction target image, the feature search unit 103 stores a status indicating a search failure. The feature search unit 103 stores, in the data holding unit 102, amounts of change in coordinates and direction of a region in the correction target image relative to the coordinates 601 and direction 602 of a corresponding patch that has been successfully searched in the reference image so that the amounts of change in coordinates and direction of the corresponding region are associated with each patch as a displacement of the patch.

As described above, the feature search unit 103 searches the correction target image for the region corresponding to each of the plurality of patches in the reference image. When a search is successful, the feature search unit 103 stores, in the data holding unit 102, the amounts of change in the coordinates 601 and the direction 602 between the patch in the reference image and the region corresponding to the patch in the correction target image.

In step S506, the feature search unit 103 notifies the control unit 106 that the processing has been completed.

The control unit 106 instructs the priority determination unit 104 to use data stored in the data holding unit 102 to assign a weight to patch data.

In step S507, where an instruction regarding a condition for priority determination is given to the priority determination unit 104, the control unit 106 sets a value serving as a threshold. The priority determination unit 104 performs processing illustrated in FIG. 4.

In step S508, the priority determination unit 104 notifies the control unit 106 that the processing has been completed.

In step S509, the control unit 106 instructs the deformation amount calculation unit 105 to calculate a deformation amount using the patch data to which the weight has been assigned and that is described in FIG. 4. The deformation amount calculation unit 105 uses the weight assigned to each patch as input in statistical processing (for example, random sample consensus (RANSAC)) with respect to each of the X- and Y-directions, assigns the weight of each patch to displacement of each patch, and obtains a deformation amount of the whole of the correction target image. Regarding a patch to which a changed weight is assigned out of patches from which displacement has been successfully searched, the deformation amount calculation unit 105 duplicates data according to a ratio of the weight and obtains a deformation amount using the duplicated data. As described above, the deformation amount calculation unit 105 uses the amounts of change in the coordinates 601 and the direction 602 obtained in the step S505 and the weight obtained in step S508 to calculate the deformation amount.

In step S510, when completing calculation of the deformation amount by statistical processing, the deformation amount calculation unit 105 notifies the control unit 106 that the processing has been completed.

In step S511, the control unit 106 instructs the deformation unit 107 to deform the correction target image. The deformation unit 107 functions as a correction unit, uses the deformation amount calculated by the deformation amount calculation unit 105 to correct the correction target image, and outputs a corrected image.

In step S512, when completing the deformation of the correction target image, the deformation unit 107 notifies the control unit 106 that the processing has been completed.

Processing in steps S503 to S512 is repeated frame-by-frame of correction target images.

According to the present exemplary embodiment, the image processing apparatus 100 reflects the priority of each patch on the calculation of the deformation amount by the statistical processing. Even where there is a direction in which the number of successful searches for patches is small, the image processing apparatus 100 is capable of generating a corrected image.

To perform positioning correction of the correction target image so that images of an identical subject are matched with each other between the reference image and the correction target image that have been captured at different times, the image processing apparatus 100 acquires patches (features) to be used in positioning. Even where directions in which displacement of patches is obtained are biased, the image processing apparatus 100 is capable of stabilizing accuracy of positioning of the correction target image with respect to the reference image.

The present disclosure can also be implemented by installation of a program that implements one or more functions of the above-mentioned exemplary embodiment in a system or an apparatus via a network or a storage medium, and loading and executing the program by one or more processors in the system or a computer of the apparatus. Furthermore, the present disclosure can be implemented by a circuit (e.g., an application-specific integrated circuit (ASIC)) that implements one or more functions.

The above-mentioned exemplary embodiment is merely an example for implementing the present disclosure, and the technical scope of the present disclosure is not interpreted in a limited manner by the exemplary embodiment. That is, the present disclosure can be implemented in various manners without departing from the technical idea or the principal features of the present disclosure.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims priority to and the benefit of Japanese Patent Application No. 2024-097685, filed Jun. 17, 2024, the entirety of which is incorporated herein by reference.

What is claimed is:

1. An image processing apparatus comprising:
one or more memories storing one or more instructions; and
one or more processors that, upon execution of the stored one or more instructions, cause the image processing apparatus to:
select from a first image a plurality of patches to be used for detecting displacement in a direction out of a plurality of directions;
search a second image for regions corresponding to the plurality of selected patches, and store amounts of change in coordinates and direction between a patch in the first image that has been successfully searched and a region corresponding to the successfully searched patch in the second image;
assign a weight of the amounts of change to the patch that has been successfully searched; and
perform positioning of the second image with respect to the first image using the amounts of change and the weight of the amounts of change to correct the second image.

2. The image processing apparatus according to claim 1,
wherein the number of patches to be used for detecting displacement in a direction that have been successfully searched is equal to or less than a threshold value, and
wherein the one or more processors, upon execution of the stored one or more instructions, cause the image processing apparatus to assign a weight of the amounts of change to each of the patches that have been successfully searched and that are to be used for detecting displacement in the direction.

3. The image processing apparatus according to claim 1, wherein the weight of the amounts of change is based on a degree of similarity between the patch in the first image that has been successfully searched and the region corresponding to the successfully searched patch in the second image.

4. The image processing apparatus according to claim 3, wherein the weight of the amounts of change is based on a degree of similarity between a direction of an edge detected in the patch in the first image that has been successfully searched and a direction of an edge detected in the region corresponding to the successfully searched patch in the second image.

5. The image processing apparatus according to claim 4, wherein the weight of the amounts of change is based on a degree of similarity between a histogram of normal vectors of respective points on the edge detected in the patch in the first image that has been successfully searched and a histogram of normal vectors of respective points on the edge detected in the region corresponding to the successfully searched patch in the second image.

6. The image processing apparatus according to claim 3, wherein the weight of the amounts of change increases as the degree of similarity increases.

7. The image processing apparatus according to claim 1, wherein the first image is captured by an imaging unit, and thereafter the second image is captured by the imaging unit.

8. The image processing apparatus according to claim 1, wherein the plurality of patches selected from the first image includes a plurality of patches for detecting displacement in a horizontal direction and a plurality of patches for detecting displacement in a vertical direction.

9. The image processing apparatus according to claim 8,
wherein each patch of the plurality of patches for detecting displacement in the horizontal direction includes a longitudinal edge component, and
wherein each patch of the plurality of patches for detecting displacement in the vertical direction includes a lateral edge component.

10. An image processing method comprising the steps of:
selecting from a first image a plurality of patches to be used for detecting displacement in a direction out of a plurality of directions;
searching a second image for regions corresponding to the plurality of selected patches, and storing amounts of change in coordinates and direction between a patch in the first image that has been successfully searched and a region corresponding to the successfully searched patch in the second image;
assigning a weight of the amounts of change to the patch that has been successfully searched; and
performing positioning of the second image with respect to the first image using the amounts of change and the weight of the amounts of change to correct the second image.

11. A non-transitory computer-readable storage medium storing a program for causing a computer to execute a control method of an image processing apparatus, the control method comprising the steps of:
selecting from a first image a plurality of patches to be used for detecting displacement in a direction out of a plurality of directions;
searching a second image for regions corresponding to the plurality of selected patches, and storing amounts of change in coordinates and direction between a patch in the first image that has been successfully searched and a region corresponding to the successfully searched patch in the second image;
assigning a weight of the amounts of change to the patch that has been successfully searched; and
performing positioning of the second image with respect to the first image using the amounts of change and the weight of the amounts of change to correct the second image.
